(19) United States
(12) Patent Application Publication
(10) Pub. No.: US 2012/0239742 A1
(43) Pub. Date: Sep. 20, 2012

(54) MOBILE SOCIAL NETWORKING ASSEMBLY AND EFFICIENT DATA EXCHANGE THEREFOR

(75) Inventors: Yaron Moradi, Kfar Saba (IL); Pinchas Ziv, Tel Aviv (IL)

(73) Assignee: MagnetU Mobile Ltd., Kfar Saba (IL)

(21) Appl. No.: 13/380,050

(22) PCT Filed: Jun. 24, 2010
(86) PCT No.: PCT/IL10/00500

§ 371 Date: May 23, 2012

Related U.S. Application Data
(60) Provisional application No. 61/269,445, filed on Jun. 25, 2009.
(60) Provisional application No. 61/269,532, filed on Jun. 26, 2009.
(60) Provisional application No. 61/338,034, filed on Feb. 16, 2010.
(60) Provisional application No. 61/338,160, filed on Feb. 16, 2010.

(51) Int. Cl. G06F 15/16; H04W 4/06

(52) U.S. Cl. 709/204

(57) ABSTRACT

The present mobile social networking assembly establishes new connections between users within the network of proximity created by the assembly and while the users mutually match the each others' data. The assembly implements a broadcast-based efficient/fast data exchange using minimal power via Dynamic Human Mobile Broadcast Networking without infrastructure demands. Implemented within a mobile telephone or as a stand-alone unit (10) for use with a mobile telephone (18), the assembly efficiently exchanges user data with other social networking assemblies and notifies users of data matches via existing mobile telephone networks (30). Power saving mechanisms include minimizing redundant data transfer and synchronizing the data exchange between users to allow broadcast sleep mode usage. In addition to social networking, the present efficient data broadcast and exchange mechanisms are useful, for example, for advertisements to potential customers in a shopping center and disseminating road hazard information to motorists.

The technology disclosed herein is applicable to mobile social networking, but it is not limited thereto. Other uses of data transfer are enabled by the present disclosure. This application claims priority to: U.S. Provisional Application No. 61/269,445, filed Jun. 25, 2009; U.S. Provisional Application No. 61/269,532, filed Jun. 26, 2009; U.S. Provisional Application No. 61/338,034, filed Feb. 16, 2010; and U.S. Provisional Application No. 61/338,160, filed Feb. 16, 2010; all four of which are hereby incorporated by reference in their entireties.

### BACKGROUND

Existing mobile products are capable of matching mobile users according to criteria, such needs or mutual interests, and the resulting matches can lead to business deals or social dating. Known mobile products of this sort rely on location-based service infrastructures such as Cellular Triangulation. The disadvantages of reliance on such infrastructures include the infrastructures' complexity, expense, limited to no scalability as required for mobile social networking, and large initial investment. Some products that match mobile users require the download of an application to users' Bluetooth-enabled mobile telephones and accordingly are limited to matching users only within a Bluetooth mobile phone range (about 10-20 meters at the most). In addition, Bluetooth requires establishment of a connection between a sender and a receiver before the sender can begin transmitting data (as opposed to enabling a sender to broadcast indiscriminately in the hopes of reaching multiple users that may qualify as receivers), so the dissemination of data is slower and often causes the loss of new possible connections. The constant use of Bluetooth required for such an application consumes high power and therefore directly and negatively affects the talk time of the user's mobile phone. Other products using GPS to locate a user's physical location consume significant power relative to that stored on a mobile telephone battery, since a user GPS location should be constantly reported to a server. In addition, products based on GPS have difficulties to work indoor (either GPS does not have a satellite signal while indoor or it is reported position is inaccurate indoor). Additional problems include location-related privacy issues, since the user location can be known/exposed either to an intermediate server or between users and may result with inappropriate use of the services.

Also, users physically carrying hardware suitable for mobile social networking desire a small size for that hardware, and as noted the stored battery power is limited. However, for effective social networking of moving users, frequent data transfer is desired, and as data are transferred more frequently more power is consumed. Accordingly, the present inventor saw a need for effective data transfer schemes that do not require a large amount of power.

### SUMMARY

The present invention creates a network of proximity based on a dynamic human mobile broadcast network that is capable of exchanging data via broadcast among a large density of users. The invention does not require complex location-based infrastructures to enable the mutual introductions of users. The present invention also provides for efficient data transfer, which minimizes the demand on the power of mobile units.

The inventors developed a social networking assembly, embodied for example as a mobile engagement platform (MEP) to solve the problems described above. The MEP offers users the possibility to make new connections based on a mutual match between matched data among even tens, hundreds or thousands of users located within the same place or network of proximity created by the MEP, while covering a radius of up to a few hundreds of meters, indoor and/or outdoor. The MEP is not based on GPS and other technologies that require knowing the user location and therefore eliminates privacy concerns associated with location-based applications. Upon a successful match, the MEP communicates with the users' mobile phones and uses the existing cellular infrastructure to deliver a new connection message to the mobile phone of the remote matched user, making it a wearable mobile social networking that delivers or exchanges match/new connection messages automatically between small or large group of users while they are located even in the same indoor entertainment place (club, pub, concert, festival, other) or outdoor.

For effective social networking of moving users, frequent data transfer is desired, and as data are transferred more frequently more power is consumed. Accordingly, the present inventor saw a need for effective data transfer schemes that do not require a large amount of power.

The MEP incorporates a novel Viral Dynamic Human Mobile Broadcast Network enabled by the usage of the effective data transfer schemes described later in this application, where each MEP may serve as a social bridge and engage MEP users who are physically located in a range that is over the supported radio range of the MEP. The MEP's Viral Dynamic Human Mobile Broadcast Network creates a Network of Proximity among MEP users in which each user carries his own profile and also the profiles received from other MEPs who pass by. Thus User A informs about user X to user C and user X and C may be introduced to each other directly through the network of proximity created by User A, although User C and X are physically located in a radio range that does not allow a direct communication.

The MEP can be used to match and make new connections with users in real-time, in their day-to-day lives out of home environments (e.g., in a mall, pub, disco, workplace, dance club, or subway). The MEP can be used to make new connections between users who have matching varying interests, such as social desires, dating, buy & sell, business matches in trade shows, photo sharing and other match-making related applications.

In addition to the above, another powerful capability of the MEP is the ability to make new connections with online social networks' users who match and share the same interests and are located in the same place or area out of home environment, while indoor as well as while outdoor. The MEP works as a personal agent for the user that automatically finds and matches him/her with their on-line or mobile social networking friends or strangers (such as Facebook, Yahoo, MSN, Google, ICQ, Twitter and others) in their vicinity.

The invention may be embodied as a social networking assembly for a local user having a local mobile telephone. The social networking assembly has a transceiving sub-assembly, a storage sub-assembly, and a processing sub-assembly. The transceiving sub-assembly has a first module that is operative to communicate with one or more remote social networking assemblies of respective remote users. The storage sub-assembly is operative to store personal profiles describing attributes of the local and remote users and search profiles describing attributes that the local and remote users seek. The processing sub-assembly is operative (1) to prepare personal profile data and search profile data for broadcast through the first module of the transceiving sub-assembly to the one or more remote social networking assemblies, (2) to receive broadcasted personal profile data and search profile data through the first module of the transceiving sub-assembly from the one or more remote social networking assemblies, and (3) to determine the degree to which data from a personal profile of one social networking assembly match data of a search profile of another social networking assembly.

The invention may also be embodied as a method of broadcasting data from a sender to at least one recipient. The method includes: receiving a broadcasted notification indicating the presence of a potential data recipient; determining from the notification whether the sender has data that the potential data recipient lacks and designating any such lacking data as candidate data for broadcast; monitoring incoming broadcasts for data that are the same as any data designated for broadcast and removing that designation for the same data; and broadcasting any data that remain designated for broadcast.

These and other embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1 illustrates an embodiment of a social networking assembly implemented in accordance with the invention;

FIG. 2 illustrates an example data structure of a personal profile suitable for use by the social networking assembly of FIG. 1;

FIG. 3 illustrates an example data structure of a search profile suitable for use by the social networking assembly of FIG. 1;

FIG. 4 is used to explain a scheme that may be implemented by the social networking assembly of FIG. 1;

FIG. 5 provides a flow chart illustrating a method of broadcasting data implemented in accordance with the invention;

FIG. 6 illustrates the structure of a broadcasted notification suitable for use with the method of FIG. 5;

FIG. 7 illustrates the cycle of broadcasting notifications, broadcasting specially-designated data, and an idle period suitable for use with the method of FIG. 5;

FIG. 8 illustrates an example format of an update message suitable for use with the method of FIG. 5; and

FIG. 9 illustrates a synchronization message suitable for use with the method of FIG. 5.

### DETAILED DESCRIPTION

The invention summarized above and defined by the claims below will be better understood by referring to the present detailed description of embodiments of the invention. This description is not intended to limit the scope of claims but instead to provide examples of the invention. Described first is a social networking assembly. Included are descriptions of exemplary embodiments, such as within a mobile engagement platform. Also described is a method of broadcasting data from a sender to at least one recipient. As discussed below, this method may be practiced with the disclosed social networking assembly, but the invention is not limited to this field of use.

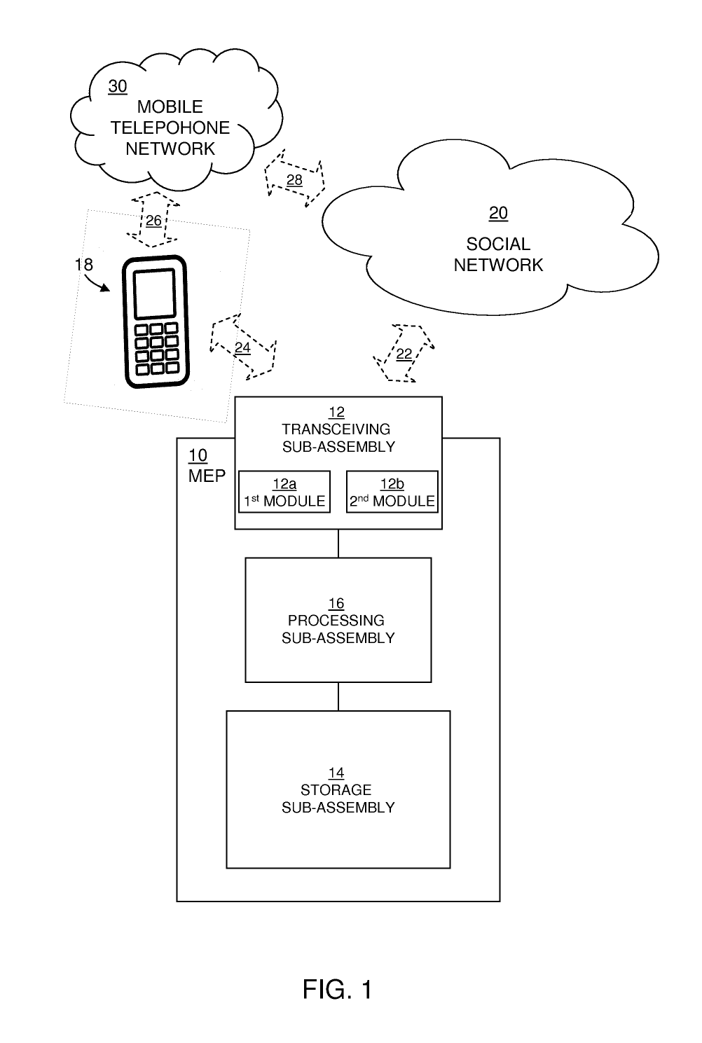

As stated above, one embodiment of a social networking assembly is embodied as a mobile engagement platform (MEP). The MEP can be implemented so that it may be worn or carried (e.g., in a USB device, dongle, pen, or keychain). As illustrated in FIG. 1, a MEP 10 includes a transceiving sub-assembly 12, a storage sub-assembly 14, and a processing sub-assembly 16. These components are discussed below. A user activates the MEP 10 and a mobile telephone 18 to enable his/her networking through a social network 20 with other users having social networking assemblies (regardless of whether the social networking assemblies are embodied as mobile engagement platforms). In the present discussion, the term “local” is used to refer to the user and mobile telephone 18 that are associated with the MEP 10. Similarly, the term “remote” is used to refer to the other users and social networking assemblies (whether the remote social networking assemblies comprise a separate mobile telephone and MEP or are embodied differently).

The transceiving sub-assembly 12 of this embodiment has a first module 12a and a second module 12b. The first module 12a communicates 22 with one or more remote social networking assemblies of respective remote users in a social network 20. Example communication protocols for this purpose are Wi-Fi, Zigbee, and Bluetooth, although the embodiment is not limited to these examples. The second module 12b communicates 24 with the mobile telephone 18, for example via Bluetooth, a cable, or a physical connector, although other suitable communication means may be implemented. The cable for this purpose might be connected to the telephone via the same port that some telephones use for transferring pictures between the telephone and a personal computer. A common connector often used for this purpose is a mini USB connector. As is evident from this discussion, the term “transceiving sub-assembly” references the appropriate hardware, software, and or firmware used for performing the associated functions described herein.

The storage sub-assembly 14 stores personal profiles and search profiles. As discussed herein, personal profiles describe attributes of the local and remote users and search profiles describes attributes that the local and remote users seek. The storage sub-assembly 14 may include non-volatile memory, such as flash memory, and the term “storage sub-assembly” references the appropriate hardware, software, and or firmware used for perform the associated functions described herein.

The processing sub-assembly 16 manages the storage, transfer, and even consideration of the personal and search profile data. It prepares profile data for broadcast through the first module 12a of the transceiving sub-assembly 12 to the remote social networking assemblies of the social network 20. Also, the processing sub-assembly 16 receives broadcasted profile data from the remote social networking assemblies through the first module 12a. Further, the processing sub-assembly 16 determines the degree to which data from a personal profile of one social networking assembly match the data of a search profile of another social networking assembly. Additional details of the functionality are provided in the present disclosure. As is apparent, the term “processing sub-assembly” references the appropriate hardware, software, and or firmware used for performing the associated functions described herein. An example component of the processing sub-assembly 16 is a Jennic JN5139 chip that contains a 32 bit processing unit, 96 Kbytes of RAM, and a 802.15.4 Radio. In some implementations, the processing sub-assembly may run code stored in the storage sub-assembly.

The processing sub-assembly 16 compares personal profiles with search profiles to determine matches for the local user. It may compare the personal profile of the local user with the search profile of a remote user, and/or it may compare the personal profile of a remote user with the search profile of the local user. After comparison of one of a personal profile and a search profile of the local user and the other of a personal profile and a search profile of a remote user, if the processing sub-assembly 16 determines that the degree to which a pair of compared profiles match is within a predetermined range, it will instruct the local mobile telephone 18 to send a message through 26, 28 a mobile telephone network 30 to the remote mobile telephone associated with the social networking assembly of the remote user.

The message that the processing sub-assembly 16 instructs the local mobile telephone 18 to send may take the form of an SMS (short message service) or MMS (multimedia messaging service) message, and the message indicates to the remote mobile telephone that there is a profile match. (An additional system server is used for processing an MMS message, as discussed below.) Alternatively or in addition, the processing sub-assembly 16 could be programmed to instruct the local mobile telephone 18 to send a command to the remote mobile telephone. An example command might be one that would open a social network application on the remote mobile telephone to facilitate interacting with online social networking utilities. Additionally, the local mobile telephone 18 can be instructed to send an SMS message to itself to provide the local user with information about the remote user as extracted from the remote user's profile stored in the storage subassembly 14.

As discussed above, the local user has a personal profile and a search profile stored in his/her associated MEP 10, the personal profile describing various attributes (qualities) of the local user and search profile describing various attributes that the local user seeks in a remote user, the successful identification being known as a “match.” Example attributes include gender, hair color, height, age, interests (e.g., hobbies), and membership in known social networks (e.g., Facebook and Twitter). A profile may also include free text entered by the local user.

The data for the local user's personal profile and search profile may be loaded into the storage sub-assembly 14 in a variety of ways. For example, the data may be loaded into the storage sub-assembly 14 from an external server via a link through the Internet, the local mobile telephone 18, and the second module 12b of the transceiving sub-assembly 12. Alternatively, the data for the local user's personal and search profiles may be loaded into the storage sub-assembly 14 from a personal computer through the transceiving sub-assembly 12. The personal computer and the MEP 10 may interface via a USB connection or via Bluetooth. Another option for loading data into the storage sub-assembly 14 is to access and use a suitable application residing on the local mobile telephone 18.

The MEP 10 may be configured to upload the data of the matched profiles to the Internet. A server accessible through the Internet may keep the uploaded data and relevant statistics, and the server may enable online engagement between the local user and the matched remote user.

The following discussion provides a description of a non-limiting example of a profile match algorithm, which the processing sub-assembly 16 executes to determine the degree to which data from a personal profile of one social networking assembly match data of a search profile of another social networking assembly. Alternate examples of profile match algorithms may be executed instead by the processing sub-assembly 16.

The personal profile in this example takes the form of a structured table containing various personal attributes about the local user, for example, gender, hair color, height, and hobbies. An analogous structure is used for the search profile to indicate attributes that the local user seeks plus a quantized measure that indicates the “importance level” or “value range” of the sought-after attribute. Such information is used to quantize the degree to which a personal profile matches a search profile.

A profile collection algorithm (discussed below) causes the MEP 10 to constantly receive and transmit profiles. The MEP 10 collects and stores “new” profiles and deletes “old” profiles, while maintaining minimal power consumption and maximizing the profile transfer among users in the social network 20. The MEP 10 submits the newly received profile to the profile match algorithm for potential identification of a profile match. Upon identification of such match, the MEP 10 instructs the local mobile telephone 18 to send a message to a remote mobile telephone associated with the remote user to notify the user of match. As an option, the MEP 10 can also notify (via the local user telephone 18) the local user of the match. Safeguards may be implemented to protect privacy. For example, the MEP may notify a user of the match without providing the matched user's telephone number.

A user notified of a match is not likely to want to be notified again of the same match a short time later. Accordingly, a timer is activated after a match is identified, and a new match notification will not be sent if the “new” match is identified within a set time period after it had been previously identified. An example time period set for this purpose is ninety days.

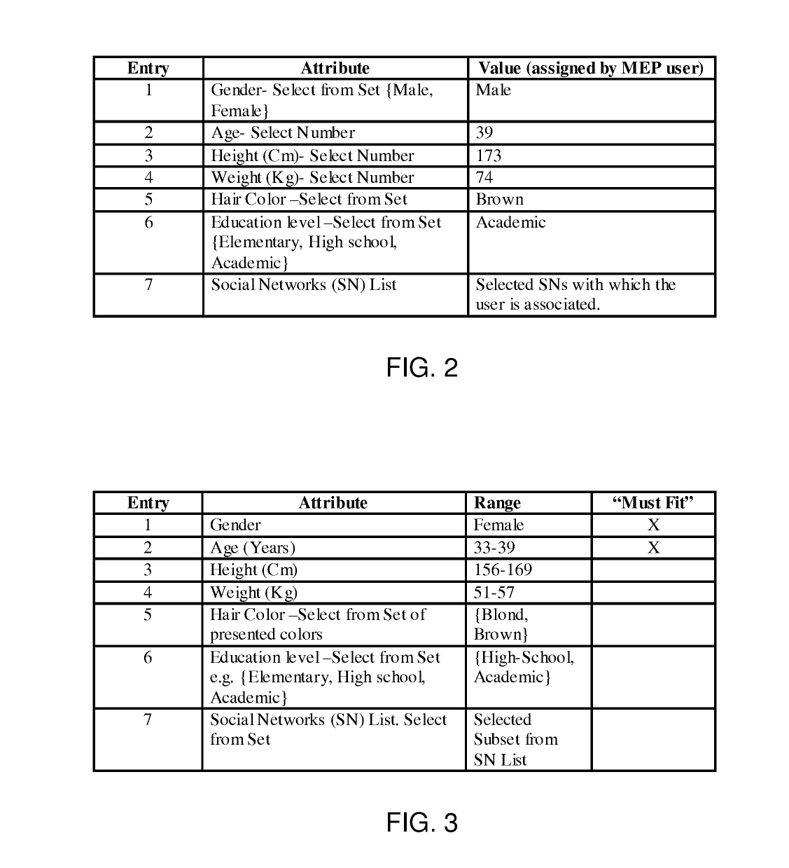

FIG. 2 provides an example data structure of a personal profile. The table contains a set of entries such that each entry has an “Attribute” and an associated “Value” assigned to that attribute. The local user assigns the “Value” during a configuration stage by accessing a presented set of values. The data structure may be modifies to allow entry of free text and graphical information, such as the local user's picture or personal logo.

FIG. 3 provides an example data structure of a search profile. The structure is analogous to that of the personal profile in FIG. 2, but for each attribute the entry has an associated record has a “Range” entry and a “Must Fit” entry.

The local user assigns “Range” value for each attribute from a set of possible selections of entries that are presented to him/her on a Web configuration screen. “Range” can be selected from a “From-To” set or a “List” set. The “From-To” set is a range of possible values for a certain attribute. For example {Age, Height, Weight}. The “List” set is a set of values selected from a known list of possible value for the attribute. For example “Hair Color” list can be {Blue, Brown, Green}. The local user can set strict requirement by selecting only one value in a list (e.g., “Education Level” {Academic} only). Alternatively, the local user may select all possible values in the List for that Attribute (e.g., “Hair Color” {Blue, Brown, Green}, or several Social Networks (e.g., Facebook, Googletalk)

If the local user does not want a remote user identified as a match if the remote user does not have certain attributes, he/she may tag the associated entry of the search profile as “Must Fit” entries. As an example, suppose that in personal profile received from a remote user value the gender attribute is “Male,” and in the search profile of the local user the corresponding attribute is “Female” and the “Must Fit” entry is tagged; there is NO match for “Gender.” An implementation of the invention may be configured such that the determination of the attribute that may be tagged as “Must Fit” are selected by the user or are a System wide parameter.

As shown in the last entry of FIGS. 2 and 3, one of the attributes may be a user's participation in known social networks. An example of a social network match definitions could be: if at least one selected social network field in the local user's search profile matches that provided in a received remote user's personal profile, then the algorithm selects from the identified matched social network (as there may be more than one social network matches) the match with the highest social network priority level (discussed below). The algorithm then identifies an associated username for the selected highest social network priority level, and this username is inserted into an SMS or MMS message to the remote user.

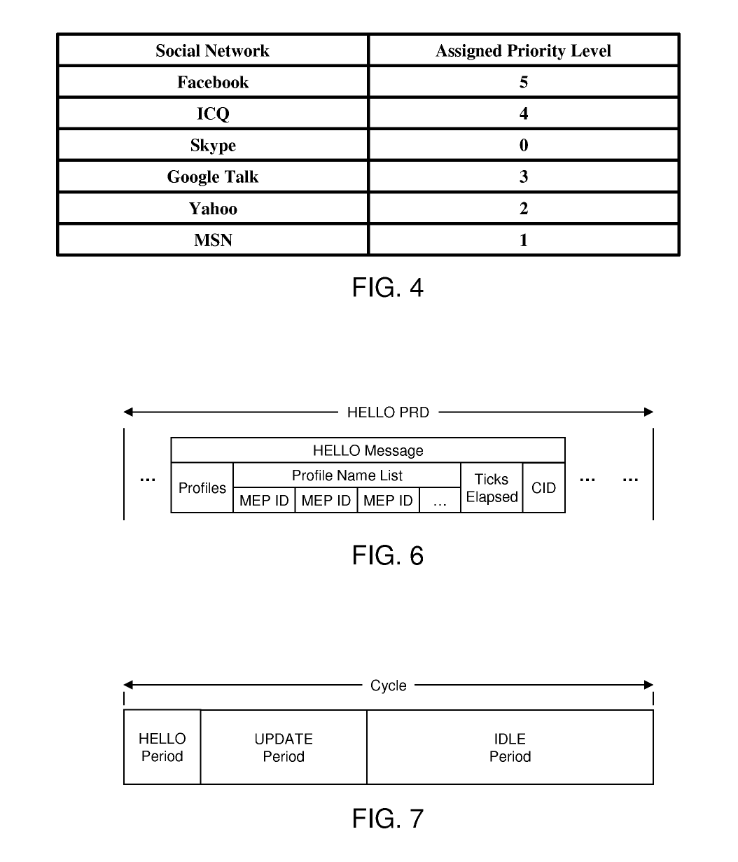

Reference is made to FIG. 4 to describe a scheme for assigning and selecting a social network match from a set of detected social network matches. A user sets in a list of social networks (all possible social networks) a Priority Level per social network. Priority level “0” is the lowest priority and, as the number increases, the Priority Level is considered a “higher priority.” The Priority Level is a system parameter and it will be pre-assigned to each social network according to business criteria. For example, consider that Facebook is assigned the highest Priority Level. Then, for several social network matches identified among the local user's search profile and the received remote user's personal profile, if the Facebook social network match is included in the set of matches, the username of the Facebook user will be included in a match SMS message delivered to the matched party.

Each social network is assigned a unique priority level. The assigned priority level is a system parameter that is transparent to the user, and it is downloaded to social networking assemblies as operational parameters. The social network priority level assignment may be changed as desired.

The match identification includes a calculation of a match level. The match level may be included in message to a user's mobile telephone indicating a profile match. The calculation of match level is described as follows:

Each attribute entry that is tagged “Must Fit” is assign a “Result” value.” A “Result” value of “1” is assigned to a compared “Must Fit” Attribute item, if the compared personal profile “Attribute” is “within” the “Range” indicated in the search profile for that attribute. If there is inequality, a “Result” value of “0” is assigned. The process is then stopped because there is no match between the personal profile and the compared search profile. If instead for each “Must Fit” entry the Result value is “1”, the process continues.

For each attribute entry that is not tagged as “Must Fit”, a “Result” value is assigned. A “Result” value of “1” is assigned if the compared personal profile's “Attribute” is “within” the “Range” indicated in the search profile for that attribute. Otherwise, a “Result” value of “0” is assigned. A “Match Level” is calculated by adding the “Result” values for each entry, excluding “Must Fit”-tagged entries. (In alternative embodiments, a weighted-sum scheme can be implemented, for example, by multiplying each “Result” value by a coefficient set between 0 and 1, a higher coefficient causing the “Result” value to carry a greater weight.)

Values ML1 and ML2 are set by a user when setting his/her search profile, or those values may be set by the system. The values ML1 and ML2 demark “Match Level Regions” of the calculated “Match Level.” “Match Level Regions” may be defined, for example, as follows:
0<“Match Level”<R1—“Attractive” Match Level
R1≦“Match Level”<R2—“Spicy” Match Level
R2≦“Match Level”—“Hot” Match Level
   (Of course, the label set may be replaced with any other desired label set, such as “Attractive,” “Hot,” and “Red Hot.”) The identified Matched Profiles (personal and search profile pair) are stored with the assigned Match Level in a “Matched Profiles” table.

A message, for example, an SMS message, is prepared for delivery to the matched party's mobile telephone. The message is delivered from the MEP 10 to the local mobile telephone using a suitable communication means, such as a cable, Bluetooth, Infrared, or physical connection. The local mobile telephone sends the message to the matched party's mobile telephone. The message content is based on selected entries from the stored “Matched profiles” table. Part of the message will be “standard” and indicate some personal information and the identified Match Type (e.g. “I am “GENDER”, “AGE” years old, I am “MATCH LEVEL” for you, I am nearby, We both like dancing and classical music, Look for me at facebook.com\first and last name, or Let's SMS.).

The matches can be categorized into three groups (“Match Types”) labeled “Local Match,” “Remote Match,” and “Dual Match.” The Match Types are described as follows:

A “Local Match” is identified by the local MEP 10 when it identifies a “Match Level” (e.g., from the possible three {Attractive, Spicy, Hot}) between its Local search profile and the received Remote personal profile. The local user may be notified about Local Matches. Notification can be delivered via MEP indicators or via the Local phone display screen in case that match notifications are sent from the MEP 10 to the local phone using an established communication link (e.g., via Bluetooth) between the MEP and the Local Phone.

The MEP application may collect statistics about the number of reported Local Matches. This collected statistics may be used by the MEP user for “measuring” his/her “success” in matching his/her profile with other people profiles. The MEP user may be able to view the collected statistics and erase it by using either a Web application or a Phone application

A “Remote Match” is identified by MEP when it identifies a “Match Level” (e.g., from the possible three {Attractive, Spicy, Hot}) between its Local personal profile and the received Remote search profile. The MEP user may be notified about Remote Matches. Notification can be delivered via the MEP indicators or via the Local phone display screen in case that match notifications are sent from the MEP to the local phone using an established communication link (e.g., via Bluetooth) between the MEP and the Local Phone.

The MEP application may collect statistics about the number of reported Remote Matches. This collected statistics may be used by the MEP user for “measuring” his/her “popularity” in matching his/her profile with other people profiles. The MEP user may be able to view the collected statistics and erase them by using either a Web application or a Phone application.

A “Dual Match” between two social networking assemblies is identified when a Local Match is detected and a Remote Match is detected.

The MEP application may collect statistics about the number of reported Dual Matches. The MEP user may be able to view the collected statistics and erase it by using either a Web application or a Phone application. Statistics may be accumulated about Dual Matches

A MEP that identified a “Dual Match” sends a message (e.g., an SMS or MMS message) to the other matched party. Such a configuration can cause both parties to send such a message. Due to viral spreading of profiles across MEPs and the lifetimes of profiles, it is possible that one social networking assembly of the pair will contain the profile of the social networking assembly, while second social networking assembly will not contain the profile of first social networking assembly. Thus, a detected “Dual Match” by the first social networking assembly will not be detected by the second social networking assembly. (The concepts of “viral spreading of profiles,” “lifetime of a profile,” and a profile's “age” are discussed in more detail below.)

Creating a network of proximity will now be described. The processing sub-assembly 16 facilitates viral spreading of data (such as personal and search profiles, as discussed in the examples that follow) among remote social networking assemblies having functionality similar to that of MEP 10. To effect this viral spreading, the processing sub-assembly 16 stores in the storage sub-assembly 14 profiles that were obtained from a remote social networking assembly (the “first remote social networking assembly”). Then, the processing sub-assembly 16 prepares those stored profiles for broadcast through the first module 12a of the transceiving sub-assembly 12 to other remote social networking assemblies (the “other remote social networking assemblies”) within the range of MEP 10, even though the other remote social networking assemblies are not necessarily within the range of the first remote social networking assembly. As a result, the recipient (“other”) remote social networking assemblies that are not located within the broadcast range of the first remote social networking assemblies are able to receive profiles therefrom nonetheless. That is, the activity of MEP 10 effectively extends the distribution of profiles to greater ranges. When the recipient remote social networking assemblies in turn broadcast the profiles further, the profiles spread to greater distances than that to which the first social networking assembly could have transmitted directly.

A MEP can offer the possibility to make new connections (for example, professional or social contacts) based on a profile match between even tens, hundreds or thousands of users located within the same vicinity, while covering a radius of up to a few hundreds of meters, indoor and/or outdoor. Upon a successful match, the MEP communicates with the users' mobile phone and uses an existing cellular infrastructure to deliver a new connection message to the mobile phone of the remote matched user. The small size of the MEP makes it easily worn or carried, which makes is easily used for social networking in that it delivers or exchanges match/new connection messages automatically between small or large group of users while they are located even in the same indoor entertainment place (e.g., club, pub, concert, and festival) or outdoors.

Discussed now are “new connection message” delivery options. Per identified match by an MEP, a “new connection message” is delivered containing information extracted from the MEP stored user personal profile. This message is delivered to the local mobile telephone utilizing for example a Bluetooth link automatically established with the MEP. Other means can be used as well, for example, a cable connection or Infrared channel. The Local phone acts as a message Gateway that passes the “new connection message” as for example an SMS or MMS message. No additional server support is required (but additional server support may be implement nonetheless as an administrative option) in order to deliver a new connection/match SMS messages among matched parties. There are two possible options for “new connection message” delivery: Direct “new connection message” delivery, and Indirect “new connection message” delivery.

Under Direct “new connection message” delivery, the “new connection message” is delivered as a “Point to Point” SMS message (utilizing standard Cellular System infrastructure) directed to the Remote phone of the matched party. It is also possible to deliver the “new connection message” via other infrastructure means (e.g., Wi-Fi connection to the Internet) that may be available for the Local phone usage or integrated in the MEP itself.

Under Indirect “new connection message” delivery, an appropriately formatted “new connection message” is first delivered by the Local phone as an SMS message via the Cellular System infrastructure or other infrastructure (e.g. Internet if available to the Local phone) to a System Server for further message processing. The System Server may append the “new connection message” sender's Picture as extracted from the System Server Data Base, and then deliver the complete message as an MMS message to the matched party Remote phone.

A social networking assembly may be configured such that its storage subassembly stores multiple personal profiles describing the local user and/or search profiles describing what the local user seeks. A user of the social networking assembly, for example, the MEP 10 described above, may select to use different profiles as a function of his/her social activities. For example, the MEP user may be interested in creating new business connections and will therefore select and program the MEP with a “Business” profile. Whenever he/she is in a conference or a big expo the MEP will make new connections between MEP users who share the same business interest. At different times, the MEP user may be interested in selecting a “Dating” profile to make new connections based on dating-related matches while he/she is enjoying free time after working hours. Also, the MEP user may be interested in engaging socially with people who share with him the same areas of interests, so he/she would use a “Socialize” Profile. There is an unlimited number of generic profiles that can be created, and a MEP user can select one or more of them and configure it according to his/her specific personal attributes. To enable multiple profile usage, the MEP may contain in its memory several profile settings. The MEP user may select the preferred profile for usage according to his/her preference at the time of selection. Multiple profiles may be selected for use at the same time.

Another possible way to handle multiple profiles is to enable the user to engage with the Web Server to download the appropriate Profile into the MEP or to use a mobile phone application to select a profile. The mobile phone application will communicate with the MEP to set the profile to the one selected by the user.

The Web Server may contain multiple sets of generic Profiles (for different social networking use cases), and the user may select one or more profiles from this set of generic profiles and configure it according to his/her personal attributes. These sets of generic profiles can be as large are desired and can be updated by the company that maintains the generic profile database.

The personal setting of those selected profiles can be maintained in the Web Server, and downloaded to the user's MEP whenever the user elects to do that. The downloading of profiles from the Web Server into the MEP can be done either via a PC, which is attached to the MEP, via a MEP USB port, or in case that the user is equipped with a Cell Phone that is equipped with Internet connection abilities (via Wi-Fi or via the Cellular infrastructure), the selected profile can be transferred from the Web server to the Internet equipped Phone and from there via the link between the phone to the MEP into the MEP (e.g. Bluetooth link). Also, the settings may be maintained using a suitable application residing on the cell phone.

A MEP can have match filters, as a MEP can be configured to continuously check whether a received profile represents a match with the MEP user profile. Several controls are given to the user in order to enable the control of the number of delivered “new connection” SMS messages.

In order to ensure that an SMS “new connection” message that was delivered to a matched party will not be repeatedly re-delivered due to a possible repeated identification of a match, whenever a “new connection message” is delivered to matched party a “Match Record” containing the MEP ID of the matched party and the time of delivery is stored in the delivering MEP storage. The MEP system maintains each “Match Record” for a duration that equals a system configuration parameter “Match Time To Live” (MTTL) (default setting is to 90 days). Once the Match Record duration in the MEP storage reaches the MTTL, this Match Record is removed by the MEP from the “Match Record” list.

A user may configure a maximum number N of “match messages” that will be delivered within the last time T duration of MEP activity (i.e. while it is “ON”). For example, N=50 “match messages” within T=12 Hour of MEP activity. The number of delivered SMS “new connection messages” is a function of the number of Dual Match detections. The number of Dual matches is a reflection of the “Popularity level” of the MEP user; thus setting the number of SMS messages (N) within a set time (T) actually reflects the Popularity Level expectations of the MEP user. The user may select his/her “Popularity level” during the MEP Profile configuration setting process. An elapsed time count is activated whenever the MEP is switched ON. An SMS “match message” delivery counter is incremented per delivered message. Once the elapsed time reaches T (meaning that the elapsed timer has counted down to zero), the elapsed timer is reset to T and the SMS “match message” delivery counter is reset to zero, so another set of up to N SMS “match messages” can be sent. Different T settings and N settings are possible and are selected by the user during the setting of profile parameters. Once the SMS “match message” delivery count reaches the value N, and the elapsed time is less then T, the MEP stops SMS “match message” delivery until the elapsed time reaches T. At this point the timer T is re-stated, and the SMS “match message” delivery count is zeroed, so the MEP can reinitiate SMS message delivery up to the set SMS “match message” delivery limit N during T.

Whenever the MEP goes into “OFF”, the elapsed time counter stops counting (is on Hold). The SMS counter is not incremented since the MEP does not deliver “match messages” while in OFF state. Whenever the MEP goes into the “ON” state, the elapsed time timer continues its count. Whenever the MEP is RESET, the elapsed time timer and the “match message” counter are reset to zero.

The following describes how contact information is transferred:

The MEP contains per user personal profile the phone number of the MEP user. This number is used by the MEP application to deliver a message to the party with whom a match was identified (i.e., a remote user) without exposing the remote user's phone number to the sender before the “new connection” message was received. The phone number of the MEP user will be delivered, as part of the Profile delivery to the other users. The message delivered to the matched user may contain a text message and optionally a picture, as pre-defined by the MEP user. In case the configuration setting indicates that a picture has to be appended to the text message, the picture will be appended by the system server (extracted from the sender profile stored in the system server database) and will be delivered together with the text message as an MMS message delivered from the System Server to the destined matched party. The continuation of the exchanges between parties that identified a match will be done at their discretion via either a phone call, SMS, MMS, Internet chat, or other means.

Many cellular phones contain records of outgoing and incoming phone calls and messages. For privacy reasons, the MEP can be configured such that the SMS or MMS messages used to contact the matched party will enable the receiving party will see the phone number of the sender, while the sending MEP user will not be able to view the phone number to which the message was delivered to (e.g. by using the phone application that allows a user to view the history of delivered messages).

MEP users that originate the “match message” may optionally elect to not reveal their telephone number and instead elect to append to the “new connection message” his/her Email address or social network ID. Such “new connection messages” are classified as “Higher Privacy” messages and they may be delivered utilizing the following SMS message delivery options: using indirect “new connection message delivery” as explained above; and using direct “new connection message delivery.” Under the latter option, the party that identified a match delivers a self addressed SMS “new connection message” (i.e. delivered to its own Cellular Phone). This message does not contain the phone number of the “matched” party but instead the Social Network name, email address or other name of that party (as extracted from the personal profile of the matched party).

Whenever a “new connection message” is delivered by the MEP, its user may be notified about such event by audiovisual means such as an Audible sensing (buzzer at a certain duty cycle/frequency), Physical sensing (e.g. vibration at a certain duty cycle generated by a MEP vibrator), and optionally Visual sensing (e.g. flashing LED at a certain duty cycle and color) or a combination of these means.

Recall that the user may upload the content of the Match Record to the system Web Server. The content of the Match Record contains the MEP IDs of MEPs to which a “new connection message” was delivered and the record has not reached yet the MTTL (match time to live). The uploading may be performed during the process of the user profile update or at any other time convenient to the user.

The capabilities that are offered to the MEP user whose Match Record was uploaded to the Web Server are as follows: The user may get additional information about each uploaded Match Record (e.g. Picture of the matched party to whom a new connection message was delivered) and other profile information filled in by matched parties. Also, the user may build his/her social friends. Further, the user may add his/her new “matched friends” (as identified by the Match Record) to his/her favorite Social network (e.g. Facebook, Twitter, etc.).

The MEP delivers a “new connection message” to the Local mobile telephone, for example, via a Bluetooth link. To enable Bluetooth transfer, the following capabilities are supported:
The Local phone being paired with the MEP. Such is a “one time” operation, done by the MEP user, in a similar procedure that is done between a Phone and a Bluetooth headset.
The MEP using Bluetooth SDP in order to identify the Phone DUN channel or SPP Channel. The identified DUN (or SPP) channel is used afterward whenever the MEP tries to connect to the Local phone.
The MEP establishing a Bluetooth connection with the Phone for the delivery of a “match message”. This connection is done between the MEP and the paired Phone.
AT+ commands for SMS message delivery (as specified for example in 3GPP 27.005 standard) being used in order to deliver the SMS “new connection message” from the MEP to the Local phone
In order to save MEP Power, the connection being either terminated or kept in a Bluetooth “Sniff” mode between “match messages” deliveries.
In case that Bluetooth Sniff mode is NOT supported by the Phone (detected by the MEP using standard Bluetooth procedures), then after “new connection message” delivery to the Local phone (or a sequence of “new connection messages” delivery), the MEP breaking the connection with the Local phone. Reconnection will be established automatically once the MEP will be ready to deliver another “new connection message” or a set of “new connection messages.”

The MEP may be managed as follows:

For MEP software upgrades, the MEP may be connected to a user's PC via a MEP USB connector. The PC will be connected via the Internet to the MEP Web site Server that will be responsible for Software (S/W) download procedures. S/W updates will attempt to maintain backward compatibility, but in the worst case a MEP will disregard Profiles received from a MEP that has a S/W level version that is too “old.” The next time that the user reconnects his/her MEP to the PC and engages with the MEP web site, the Server will download the MEP with the latest S/W version.

The MEP device is configured as followed:

Regarding user defined operational parameters, to enable the user to configure his/her Profile, the user is assisted by a Web based “Wizard” configuration tool. The MEP configuration parameters affect the behavior of the MEP. Once the MEP is connected to the PC, and connects to the Website, the web site presents to the user its current profile. The user can update the profile and once done, the updated profile is downloaded to the MEP and also saved in the Web Server. The following shows examples of possible MEP operational configuration parameters that may be set by the MEP user:
“Set Match Notification”: MEP Vibration, “Beep” tone, or optionally flashing LED, or a combination of the above. The notification will be activated for duration of 3 seconds. The notification will be activated per “new connection message” delivery from the MEP to the Phone.
“Append Picture (Yes/No)”. This parameter is set to “Yes” in case the sending MEP user decides to accompany a Picture with the delivered new connection message. In this case an MMS message will be delivered to the remote matched user. In case MMS service is not available for the receiving party, the delivered message will not include the Picture. In case a Picture of the sending user is not available in the Profile of the sender, an SMS message will be delivered to the remote matched user.
“Set Higher Privacy”: When Set, the new connection message contains the Email Address of the “new connection message” sender.
Set Phone Number: Contains The Phone number of the MEP user.
Set Language; The language that will be used for the delivery of “new connection message” text.
“Set Popularity Level”—Popularity Level is a threshold set by the user. It limits the maximal number of SMS messages N that will be set within a period of time T. A set of possible Ns and Ts are offered to the user for selection.

System parameters that affect the operation of a MEP within a system of MEPs are downloaded to the MEP as part of the MEP device configuration process. It is not necessary to download a new Software version whenever MEP system parameters are changed. Thus, in case that the required changes constitute of System parameter modifications as well as User defined operational parameters, only the new set of modified parameters is downloaded to the MEP. The following list is an example of possible system parameters.
“Match Time to Live (MTTL)” parameter: This parameter determines the lifetime of a formerly identified match between two (sender and recipient) MEP IDs. The MTTL is activated whenever a “new connection message” was delivered. As long as the MTTL is active the sending MEP will not deliver a “new connection message” to the destined MEP.
Various system parameters related to the “Profile Collection Algorithm” (discussed below)
Various system parameters related to the “Profile Match Algorithm”

The MEP user may use the following Switches and Buttons in order to control the MEP operation.
“On/Off” Switch: MEP users can Activate/De-Activate the MEP utilizing a MEP On/Off switch.
Phone Pairing Push Button—This button needs to be depressed for several seconds in order to place the MEP in a Bluetooth pairing Mode.
MEP Reset Push Button—may be used in order to force the MEP to restart its software application program.

The MEP may contain two Leds (for example, Red and Blue), which are used to indicate to the MEP user information regarding the MEP status. An example for the usage of the MEP Leds is:
Red Led constantly lit—Battery is being charged
Blue Led is constantly lit—Battery is fully charged and the MEP is in “OFF” state (i.e. not active)
Red Led blinking slowly—Battery is almost completely discharged and needs to be re-charged
Blue Led blinking slowly: MEP is in “ON” state (i.e. active)
Red and Blue Leds are blinking alternately—MEP is in Bluetooth Pairing state

One of the possible MEP embodiments is a stand alone embedded device. In this configuration the MEP gets its operational power from a battery that is part of the MEP hardware. The battery is rechargeable, and it is automatically charged whenever the MEP is connected to an active PC USB port. The user connects the MEP to the USB PC port for either Profile modifications or just for recharging the MEP battery.

The following addresses privacy and security issues:

Regarding code hacking, to protect the MEP application code it can be downloaded in an encrypted format. The Decryption Key is stored in the MEP in its OTP (One Time programming) memory. The key length may be 128 bits. The OTP is “burned” during the production process. The Key that is stored in the OTP can be maintained as a company secret.

As an option, the KEY may be downloaded (via an SSL connection) from the Server via the PC to the MEP. The KEY is then burned into the MEP the First time that the MEP is connected to a PC in order to Set its first Configuration and download the Code.

Another option is to maintain a KEY per MEP ID or use the Same KEY for all MEPs. If a KEY is maintained per MEP ID, it is the responsibility of the System Server to maintain the association between that MEP ID and its stored KEY. Thus, it will download encrypted file according to the MEP stored KEY in its OTP memory.

Connecting a MEP to a PC or to an SDK of some sort and reading the Algorithm Content of the MEP RAM (i.e. decrypted “Profile Collection Algorithm” and decrypted “Profile Match Algorithm” Code and Data Structures) should be blocked. For example, in order to eliminate such possibility, whenever the MEP will be connected to a PC via its USB port, the MEP application will detect that the USB is attached and will initiate a Code Erase process, which will erase from the MEP RAM the protected Code related to “Profile Collection Algorithm” and “Profile Match Algorithm” and related Data Structures.

A System Server maintains the MEP security Key(s) and is responsible for Key management procedures. The MEP key may be delivered to the MEP when MEP is connected to the System Server via a PC for configuration parameter setting. The System Server will establish a secured SSL connection with that PC, and via it a Key will be delivered to the connected MEP. It should be noted that hackers would find it difficult (though not impossible) to extract the Secret Key from a hacked MEP. If desired, for example, by market demand, the Key used will be based on PKI (Public Key Infrastructure).

An option is to use over the air transmitted message encryption. If this option is used, the KEY will be a company secret. The same KEY for over the air message encryption will be used in all MEPs. If there is a KEY breach of that KEY, it is possible to generate a new KEY and to deliver it to each MEP whenever it connects to the PC for Application Code upgrade or Configuration upgrades. Recall that Downloads are Secured. The transmitted message encryption reduces the probability of system “jamming” by cloning MEPs. Encrypting the over the air-transmitted messages also prevents “eavesdropping” of exchanged Profiles.

Regarding MEP authentication, each MEP is identified via a MEP ID. The MEP ID is stored in the MEP together with the encrypted MEP ID. Whenever the MEP is connected to the MEP Website (via the user's PC), the MEP Website Server reads both values (i.e. the MEP ID and the Encrypted MEP ID). The MEP Website Server, utilizing the MEP encryption Key (known to it) decrypts the read encrypted MEP ID value and compares the result with the read MEP ID. In case that there is a match between the Decrypted MEP ID value and the MEP ID, the MEP Web Server allows the user to continue his/her configuration procedures.

Regarding authentication of the MEP user phone number, such authentication is used in light of the possibility that someone might purchase a MEP and try to feed it (via the profile configuration process) with a “MEP User Phone Number” that belongs to somebody else (i.e. not the MEP user). Such “forging” will cause this MEP to “contaminate” other MEPs with a Phone Number of some intended “SPAM target user”. This targeted user will be SPAMed by “new connection messages” that will be sent by all those MEPs that will find a match with the “forging” MEP. The following Authentication procedure is an example of a procedure that prevents such forging.
a) A MEP user configures a profile in the usual fashion—Via Server SSL protected session from the PC to the Server.
b) The user enters a contact “MEP User Phone Number”
c) The System Server generates “Reference Number” and presents it to the users PC screen. The System Server maintains the association between the MEP User Phone Number and the Reference Number.
d) The user creates and sends a “registration” SMS message from his/her Phone to the Server—The message content equals the Reference Number that was presented to the MEP user in step c above.
e) The System Server confirms/denies user authenticity: it compares the received Phone number (part of the “registration” SMS message) with the Reference Number (contained in the content of the “registration” SMS) against the MEP User Phone Number (entered in step a).
f) The System Server Approves/Denies “registration” via appropriate message to the PC.
g) In case of approval, the generated Reference Number may be appended to the MEP profile, and it can be used by the MEP application whenever it delivers a “new connection message” to a Remote user via the System Server.
   Note that the above phone “registration” process is done only whenever the MEP first creates or modifies his/her Profile associated Phone Number.

The following Authentication procedure is another example of a procedure that prevents forging.
a) The Web server generates an Phone Authentication Code and delivers it via the Internet Link to the MEP, which is connected to the Website during the profile configuration process.
b) A MEP application program generates a self addressed SMS message, which contains the received Authentication Code.
c) The user receives that SMS message with his/her Phone.
d) The user enters the received Authentication Code in the appropriate field in the Web page. (That is, it is delivered to the server.)
e) The Web server verifies that the code entered by the user (step d) equals the Authentication code that was delivered to the MEP (step a).
   When using a self addressed message for the authentication, a special-purpose SMS message server is not needed.

The preceding non-limiting example implementations concentrated mostly on embodiments in which the social networking assembly is implemented as a MEP. However, the invention is not limited to such embodiments. For example, the transceiving sub-assembly, the storage sub-assembly, and the processing sub-assembly may be implemented entirely within a mobile telephone, and there would be no external mobile engagement platform. Alternatively, the social networking assembly may be implemented such that each of the transceiving sub-assembly, the storage sub-assembly, and the processing sub-assembly individually are implemented either within the local mobile telephone or within a mobile engagement platform. In this implementation, the profile collection algorithm and the profile match algorithm may be executed on either the mobile telephone or on the mobile engagement platform, and profiles may be stored on either element.

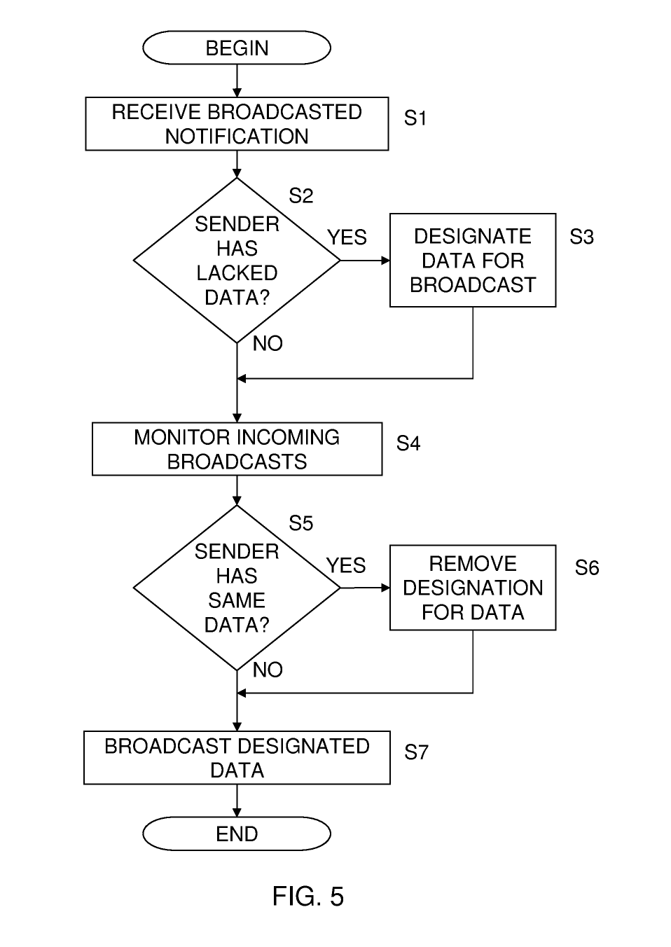

As stated above, the present invention may also be embodied as a method of broadcasting data from a sender to at least one recipient. This embodiment is now described with reference to the flowchart of FIG. 5.

It needs to be determined which data the sender will send, so an early step in the practice of this embodiment is the sender receiving a broadcasted notification indicating the presence of a potential data recipient. (Step S1.) If this method is applied in the context of a network of social networking assemblies, the notification may include information as illustrated in FIG. 6. (The notification is sometimes referred to as a “HELLO message” in the present disclosure.) In this example, the broadcasted notification includes a personal profile describing attributes of the potential data recipient, a search profile describing attributes that the potential data recipient seeks, a list of profile names (“MEP ID”) for which the potential data recipient has associated profiles, and an indication of time that has elapsed from a set reference (“Ticks Elapsed”). The attributes in the profiles typically human attributes, the invention is not limited accordingly.

Social networking assemblies in the network of this example repeatedly send such notifications to indicate their presence to each other. The notifications may have varying types of information as will be discussed below.

Then, the sender determines from the notification whether the sender has data that the potential data recipient lacks. (Step S2.) In the context of a network in which a social networking assembly sends a HELLO message as shown in FIG. 6, the data can be profile data (personal and search) of many users. The HELLO message has a profile name list of MEP IDs to indicate which profiles the potential data recipient already has. The recipient of the HELLO message (referred to as the “sender” in the discussion, because it will broadcast data) can determine from the profile name list whether the sender has profiles that the potential data recipient lacks.

The sender maintains a list of candidate data to broadcast. The list can include all data that it has, which are suitable for broadcast. For example, the data may be personal and search profiles of members of a social network. If, after receiving in Step S1a broadcasted notification from a potential data recipient, the sender determines in Step S2 that it has data that the potential data recipient lacks (the “lacked data”), the sender designates the lacked data as candidate data for broadcast. (Step S3.) The data are labeled “candidate data,” because conditions may dictate that some of the date will not be broadcasted as discussed below.

Often, the sender is in an environment in which other senders are broadcasting data to data recipients. To conserve resources, such as power for broadcasting and bandwidth shared for the broadcasts, the sender monitors the incoming broadcasts from the other senders for data that are the same as any data that the sender had designated for broadcast in Step S3. (Step S4.) In the context of a network in which a social networking assembly receives data broadcasts from other social networking assemblies, the data may be personal and search profiles of other users. If the sender detects data in the incoming broadcasts that are the same as data that had been listed as candidate data (Step S5), it removes that designation for that particular data. (Step S6.) For example, if the sender had designated profile data A as candidate data and later determined that user B already broadcasted profile data A, the sender removes the designation of profile data A as candidate data because it would not be as useful to send that data again. The potential recipient that broadcasted the notification of Step S1 would likely have already received that data from the broadcast monitored by the sender in Step S4.

Some of the data that the sender designated as candidate data will still carry that designation. Accordingly, the sender broadcasts the data that remain as designated for broadcast. (Step S7.)

A HELLO message was discussed above (an example of a “broadcasted notification) with respect to step S1 of an exemplary method embodying the invention. A social network assembly, for example, a MEP, can be configured to regularly send such a HELLO message in a cycle as follows:

Each MEP broadcasts one HELLO message per HELLO period (“PRD”). (FIG. 6 is not “drawn to scale.” That is, the duration of a HELLO message may be much less than the HELLO period, and the message may be broadcasted at any time during the period.) The HELLO message submission time to an 802.15.4 MAC layer of the MEP is selected in even distribution from the HELLO PRD (sometime referred to as the “HELLO Cycle”). Once the HELLO submission time is selected, the HELLO message is submitted to the MEP MAC transmission buffer, and a CSMA/CA procedure takes place. The goal is to spread the HELLO transmission in order to reduce HELLO message collisions due to “hidden” MEP transmissions.

The HELLO message period duration equals the HELLO PRD. The HELLO PRD may be implemented as a preset system parameter and optionally adjusted dynamically by each MEP as a function of its sensed “channel activity”. A HELLO PRD that is too long reduces the number of collected profiles (especially in a fast moving MEP environment), while a HELLO PRD which is too short increases the consumed power due to an unnecessary repeated transmission of HELLO messages, and the short period loads the channel, thus affecting profile collection efficiency within a given time. An extremely short HELLO PRD may also reduce the number of collected profiles due to extreme channel load.

When a MEP receives a HELLO message, it records the reception time and takes the following actions: It synchronizes the system in accordance with a “MEP Coordinator Time Algorithm” discussed below. If the received sender profiles (contained in the HELLO message) are not contained in the MEP profile storage, those profiles are added (to the receiving MEP profile storage), and the “time to live” (“TTL”) timer is set to TTL. (The TTL may be a system configuration parameter, or it may be adjusted by the MEP according to application needs. For example, in a fast moving environment as sensed by an accelerometer in the MEP, the TTL can be set to a short duration to minimize the distance covered during the viral spreading of profiles as discussed below) If the received profiles already exist in the receiving MEP profile storage, TTL timer is set to the TTL system parameter value. The name of the HELLO message sender is added to a “Neighbor List” of the receiving MEP. The names contained in the Profile Name List of the HELLO message are added to a “Neighbor Profile List.” A MEP Neighbor is a MEP that its HELLO message was received by the MEP during the last cycle of Profile collection. Each entry in the “Neighbor List” contains the Neighbor Name and the list of Profiles (the neighbor profile list) stored at that neighbor's profile storage.

The MEP continues to collect HELLO messages and to perform the actions described above for each received HELLO message. At the end of each HELLO period, each receiving MEP will contain the updated Neighbor List where each entry of the neighbor list contains the list of Profile Names stored at that neighbor storage. A system parameter determines the maximal number of Profiles that may be stored. Thus, the PL list is limited in its length.

If the HELLO message length exceeds the maximal message length permitted by the radio channel, the HELLO message is built out of the MEP personal and searched profiles and an appended limited number of IDs (as per the message length constraint permits) to be contained in the PL List. These IDs are selected in a cyclical fashion from the stored PL list where per HELLO PRD the MEP continues the selection from the last ID that was appended to the former HELLO message.

The method discussed above may be practiced such that a broadcasted notification is only received during a first time period, the designated data is only broadcasted during a second time period, a repeating reception/broadcast cycle is formed having a sequence including the first time period, the second time period, and a third time period, the third period being a time in which no broadcasted notification is received and no designated data are broadcasted. Such will be described with respect to FIG. 7, in which the first time period is labeled the “HELLO Period,” the second time period is labeled the “UPDATE Period,” and the third time period is labeled the “IDLE Period.” Note that, although the third period in this example immediately follows the second time period, the method could be practiced instead with the third period occurring between the first and second time periods.

In the present example, the update cycle begins with the termination of HELLO Cycle. The MEP activates an UPDATE period timer, the UPDATE Period being a system parameter equal to the duration of the UPDATE Cycle. This timer measures the elapsed time from the beginning of the UPDATE Cycle. When this timer fires (indicating the time has run out), the UPDATE process terminates.

During the UPDATE period, the MEP performs the following procedure per received UPDATE message to identify whether its profile storage contains Profiles in which its immediate neighbors lack. Each MEP profile storage contains Profiles of MEPs that were accumulated over time (i.e. not only those that were received during the last collection cycle). Per each neighbor list entry, the algorithm identifies whether that neighbor lacks any Profiles that are currently stored by the MEP that performs the comparison. This identification is executed by comparing, per neighbor list entry, the neighbor profile list of that neighbor with the names of profiles stored in profile storage of the comparing MEP. Per each identified “Missing Profile” name, associated Profile is extracted from the MEP profile storage and added to temporary storage that contains the identified “Missing Profiles”.

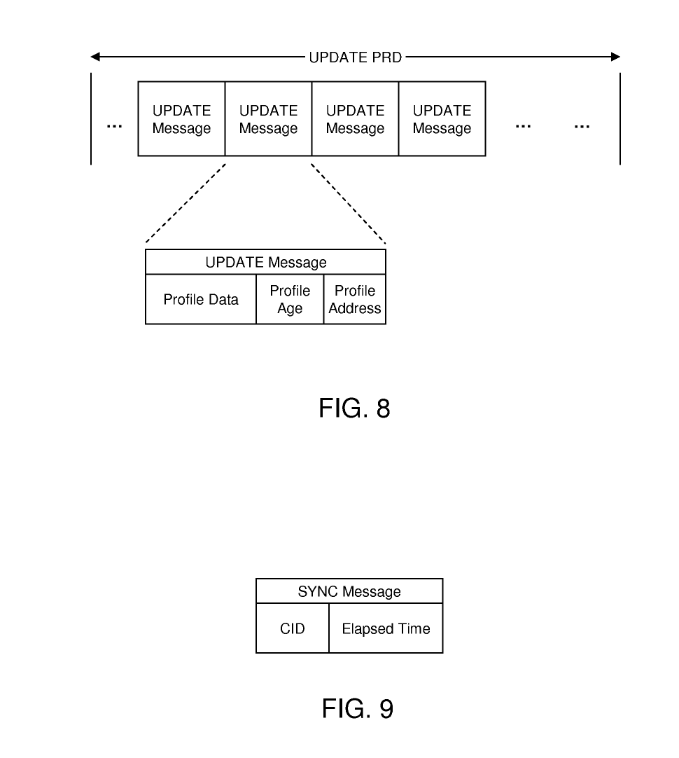

After all neighbor list entries are checked, the MEP prepares an UPDATE message that contains all of the collected “Missing Profiles”. An example format of an update message is illustrated in FIG. 8. Although the MEP has prepared a “draft” UPDATE message, this draft gets updated as the MEP receives UPDATE messages from other MEPs, as long as the “draft” UPDATE message has not yet been submitted to the MAC layer.

Note that only a single copy of each missing profile needs to be represented in the UPDATE message, since in case that several neighbors are identified as missing a certain Profile, a single Broadcast of that Profile is relied upon to reach all (or most) those neighbors. Preferably, only one UPDATE message may be transmitted by a MEP during the UPDATE PRD.

It is possible that several MEPs will be ready to transmit the same UPDATE message. The same broadcasted UPDATE, received by several neighbors may be used to update all of them. In order to minimize the number of same UPDATE message transmissions by multiple MEPs, an UPDATE broadcast may be performed as follows. Note that this procedure may be implemented using several variants, but the leading guideline is that unnecessarily repeated UPDATE message transmissions will be minimized.

First, the PCA application software selects an UPDATE “message submission time” to submit to the MAC transmit buffer. Selection is done in even distribution from the UPDATE PRD. Then, activate a timer UPDATE Message Submission Timer (UMST) tuned to fire at the selected “message submission time”. When UMST fires, submit the UPDATE message to the MAC transmit buffer. If the UPDATE message length is longer then the maximal message length allowed by the MAC, submit the UPDATE message as a set of several consecutive messages, each containing part of the original UPDATE message. As long as UMST has not fired, process each received UPDATE message and generate (if necessary) a new UPDATE message. After message submission to the MAC layer, clear the Neighbor List (will be renewed during the next “HELLO” period).

The goal of selecting a random “message submission time” is to “spread” the transmission time of pending UPDATE messages and thus minimize UPDATE collisions caused by simultaneous UPDATE transmissions from “hidden” sources that belong to different CSMA/CA domains. This gives a chance for each MEP that received an UPDATE message to update its Profile Stored (profile storage) list with the newly received Profiles delivered by the received UPDATE message.

Nonetheless, it is still possible that a “redundant” UPDATE message will be transmitted due to some implementation dependent “race” conditions in the procedures described above. It is also possible that topology situations may prevent some neighboring MEPs from receiving a broadcast UPDATE message. Thus, multiple similar UPDATE messages will be transmitted within the same UPDATE cycle. No significant harm is caused due to the transmission or reception of a redundant UPDATE. The “harm” is limited to wasting channel bandwidth and MEP power.

In a completely static environment, the UPDATE cycle will finally terminate, because no new UPDATE messages will be generated. That is, profiles will propagate “slowly” among adjacent and non adjacent MEPs. Eventually only HELLO messages will be transmitted, because the UPDATE process will not reveal any need to transmit an UPDATE message. In a dynamic environment where MEPs are changing their relative positions, new UPDATE messages will be generated as per MEP movements.

As discussed above, the method may be practiced so that a sequence having only broadcasted notifications during one period and broadcasted data during another period may also have a third time period (labeled “IDLE Period” in FIG. 7) in which no broadcasted notification is received and no designated data are broadcasted. Transmitting and receiving components may transition to a sleep mode during the third time period. During this time period, several MEP housekeeping processes may take place, such as the execution of the Profile Match Algorithm (discussed above) and the delivery of match messages to the Local phone via a Bluetooth connection between the MEP and the Local phone. Any cycle duration adjustment that results from the “Coordinated Time Algorithm” (discussed below) is done by extending or shortening the current IDLE duration.

In a typical embodiment of the invention, each stored profile has a preset Time To Live (TTL). That means that a Profile that propagates across MEPs will be kept in the system of MEPs for its TTL duration. The TTL can be a static system parameter or dynamically set by each individual MEP as a function of several local parameters measured by the MEP. A system of MEPs is a collection of MEPs that are distributed across a certain area. The “Radius” of the area can be much longer then the range that covers a single CSMA/CA Domain, as explained below.

The recipient of a profile receives a Profile either from an immediate neighbor of the MEP or the profile is delivered via an UPDATE message that contains a Profile that was propagated across several MEPs. Thus, it is “older” then the Profile that was received directly from a neighbor MEP. The “AGE” of a received Profile indicates how “old” is the profile. Because propagation of Profiles across MEPs which are not in the same CSMA/CA Domains requires more than one Cycle, the AGE of a Profile received due to such propagation will indicate how long it took it to propagate and thus indirectly be related to the distance between the Profile Originator and the Profile recipient.

Note that a “long” TTL “helps” to reduce unnecessary transmissions of UPDATE messages, especially true in a completely “stationary” MEP environment. On the other hand, in a “dynamic” environment, where MEPs are constantly moving, and possibly even at high speed (e.g., in a freeway environment), a long TTL increases the chance that a received profile is one that was firstly received by a MEP that was far away, since it managed to simply hop many times across many MEP during the TTL of this profile. Such received profile may not be an “interesting” profile since its Owner is not within the range of interest for Profile collecting MEPs.

The TTL gives the system of MEPs the following capabilities: The TTL effectively serves as an estimated measure of distance that limits the propagation distance from the MEP that is originator of a Profile (sends the explicit profile of that MEP using the HELLO message) to the Profile recipients. The system of MEPs attempts to limit the distance of Profile propagation in order to create a Social Networking geographical locality among the MEPs that share their profiles. The dynamic adjustment of the TTL enables correlation of the duration of a stored Profile to the density of system of MEPs, thus increasing the exposure of the MEP to as many newly received profiles as possible under the constraint of a limited Profile Store storage. The TTL enables the propagation of Profiles across a system of MEPs, where the propagation of Profiles is performed by the movement of the MEPs themselves as well as natural Profile propagation via an UPDATE message propagating across several CSMA/CA Domains, where the UPDATE messages are delivered by MEPs that reside in areas which overlap CSMA/CA Domains. The TTL duration serves as a “yardstick” that affects the range of Profile propagation.

The following describes the local parameters that are measured in order to determine and set the MEP TTL:

Regarding setting the TTL for a dense MEP system, the arrival rate of Hello messages during a HELLO Cycle is measured by each MEP. As the density of received HELLO messages increases, the TTL value that is set by the MEP decreases. Such dynamic adjustment reduces the lifetime of stored Profiles in the MEP Profile Store, thus enabling the reception and storage of newly received profiles in the limited Profile Store storage. The fact that the TTL is decreased thus causing the faster deletion of Profiles from Profile Store, coincides with the MEP system goal which is to collect as many profiles as possible within a given amount of time while drawing minimal amount of power.

Regarding setting the TTL for sparse MEP systems, when the system of MEPs is sparse, few HELLO messages are received per HELLO Cycle. Since the MEPs are sparse, the natural viral propagation of Update messages via MEPs that reside in the area of adjacent CSMA/CA domains is limited. In such case it is important to increase the TTL thus allowing for viral profile propagation using the physical movements of MEP owners from one CSMA/CA domain to another non-overlapping CSMA/CA Domain. The longer TTL increases the chance that the Profile will reach other MEPs via the physical movements of MEP.

Regarding setting the TTL for a limited profile store, a MEP's limitation is determined by the hardware resources allocated for Profile Store. In order to allow the system of MEPs to collect as many Profiles as possible within a given time, it is important that in order to relieve storage space for newly received profiles the MEP will be able to remove from the MEP Profile Store any profile that was formerly received and processed by the Match Algorithm.

To allow for the above, the Profile Store is handled as a First In First Out (FIFO) queue. Whenever the Profile Store is not full, any newly received profile is stored in it. Whenever a newly received Profile reaches the MEP when the Profile Store is Full, and in case that the newly received profile AGE is “younger” then the “oldest” profile in the MEP Profile Store, the PCA removes from the Profile Store the “oldest” Profile and makes room for the newly received Profile. The reason for selecting the “oldest” profile is due to the fact that there is a good chance that this “oldest” Profile was already delivered via UPDATE message to neighboring MEPs and is already propagating in a viral fashion to other MEPs.

To limit the lifetime of a Profile across the system to the TTL, each delivered profile will carry with it its “AGE” (FIG. 8). In order to measure the Profile “AGE”, the following procedure is performed per received Profile:

The TTL Timer is set to the TTL value Per delivered Explicit Profile in a HELLO message. The TTL Timer will count down from TTL to Zero. The “AGE” of the TTL Timer value represents “how old is the Profile”, the lower the TTL Timer value the “older” is the Profile. As long as a Profile resides in the Profile Store, its associated TTL time decreases. Once the timer value reaches “Zero”, the profile is removed from the profile storage. The following is performed:
Per received Profile that is identified as a “new” Profile (“new” means that it is not stored in the MEP Profile Storage), Copy the Profile “AGE” to the TTL Timer responsible for the newly received Profile.
A profile which is sent explicitly (as part of the HELLO message) will be delivered with AGE=TTL.
A profile that is delivered via an UPDATE message will carry the received AGE of that Profile as indicated by its TTL Timer. It is very likely that the AGE of a profile carried via an UPDATE message will be “older” then the AGE of a Profile carried via an HELLO message, since it may be a Profile that was carried via viral spreading of Profiles and got “older” during the propagation process.
Per each Stored Profile that its TTL timer fires (i.e., count down has reached zero time), remove the Profile from the profile storage of the MEP.

Each profile that is delivered in an UPDATE message is appended with its current value of the TTL timer (i.e., its “AGE”).

In case the received Profile already exists in the MEP profile storage, the “AGE” of the received profile is compared to the “AGE” of stored Profile. In case the received profile is “younger” (i.e. its TTL timer value is higher then the current value of the TTL timer of the stored Profile), set the TTL Timer for that profile to that of the received TTL Timer value.

As was formerly mentioned Profiles propagate from one CSMA/CA Domain to another CSMA/CA Domain in a viral fashion. Profiles propagate in a viral fashion utilizing two propagation methods: “natural” propagation and “Physical” propagation. Both viral spreading methods are explained below. Both viral spreading methods are continuously and automatically performed with no user intervention.

Profiles propagate via viral spreading in a “natural” fashion by MEPs that reside in the overlap area of several CSMA/CA Domains. The Profiles stored by these MEPs are delivered via UPDATE messages to their neighboring MEPs

The Profiles that are delivered via the UPDATE message may contain Profiles that were formerly collected from a different CSMA/CA Domain. Thus, per UPDATE message delivery “natural” propagation of profiles across CSMA/CA domain may occur.

The propagation of a profile delivered via UPDATE message continues as long as the TTL of that profile has not reached its “AGE” limit. As was explained above, once a Profile reaches its maximum “AGE”, it is removed from the Profile Store of the MEP.

The propagation speed is dependent on the Cycle duration of the MEP system. Per delivered Profile during UPDATE period and assuming that the delivery was successfully received by neighboring MEPs within the radio coverage range of the MEP that transmitted the UPDATE message, the maximal distance that a Profile can propagate during a MEP Cycle duration equals to the Radio Range/Cycle Duration. For example, if the Cycle duration is 2.5 Seconds and the MEP Radio Range is 15 meters, then the maximal “natural” propagation speed is 6 Meters/Second (21.6 Kilometer/Hour).

The maximal “natural” propagation distance is determined by the TTL and the “natural” propagation speed and equals TTL*“natural” propagation speed. For example, if the TTL is set to 300 Seconds, and the “natural” propagation speed is 6 Meters/Second, then the maximum “natural” propagation distance equals to 600*6=1800 meters. Clearly, this distance is a best-case estimate, since it assumes perfect radio coverage and continuous success in delivery of UPDATE messages to neighboring MEPs.

Regarding “physical” viral profile spreading, the spreading of Profiles that are stored in the MEPs Profile Store can be performed by the fact that a user that happen to reside in a certain CSMA/CA Domain, changes his/her geographic position and walks while carrying the MEP into another CSMA/CA Domain (i.e. the “new” CSMA/CA Domain). The “new” CSMA/CA Domain may be located in a geographical location that is much farther then the radio range of the MEP. In such case the Profiles that are stored in the MEP carried by the user will be distributed to the MEPs in the “new” CSMA/CA Domain.

The Profiles propagation speed is basically the speed of the user carrying the MEP. For example, for a walking user, the propagation speed is in the order of the walking speed of the user. Clearly, though, the actual delivery of profiles carried by the MEP is also a function of the performance of the Profile Collection Algorithm (PCA) when the user enters the “new” Domain and the “entering” MEP attempts to deliver “missing” Profiles to the MEPs in the newly entered CSMA/CA Domain.

The profiles that are delivered to the “new” CSMA/CA Domain are missing Profiles of MEPs residing in the “new” CSMA/CA Domain. Those missing profiles are carried in the Profile Store of the MEP that entered the “new” CSMA/CA Domain. Delivery of missing Profiles from the MEP that entered the “new” CSMA/CA Domain to the current members of that Domain is performed according to the rules of the PCA algorithm.

The “physical” viral spreading can cross many CSMA/CA domains along the route of the user that carries the MEP. The TTL of the profiles stored in user's MEP determine the distance of the viral spreading. A longer TTL causes the distance that can be covered to be longer.

The repeating reception/broadcast cycle (see again FIG. 7) may be synchronized with repeating reception/broadcast cycles of remote entities, such as other social networking assemblies. Details of one example are as follows:

The system “cycle” is build out of a “HELLO Cycle” (it's duration is PRD) followed by an “UDATE Cycle” followed by an “IDLE Period. Thus, the Cycle duration=HELLO Cycle+UPDATE Cycle+IDLE Period.

During the IDLE Period, the MEP minimizes its power consumption by turning off its Radio and attempts to minimize any processing. The duration of HELLO, UPDATE and IDLE are system parameters which are known to all MEPs

The goal is to synchronize the entities that are close to each other (i.e. in the same CSMA/CA Domain) so that their HELLO cycle will start at the same time. Such synchronization will maximize the number of HELLO messages that will be received during the HELLO period and minimize the required number of UPDATE messages. Also, when the MEPs are well synchronized with each other, no transmission/reception will take place during the IDLE period, and thus the PCA transceiver can be placed in the sleep mode during the IDLE period.

One possible way to achieve the synchronization is the scheme the “Coordinated Time Algorithm” described next. As will be apparent, the synchronization is set by a process that includes selecting one entity from among a group of broadcasting entities, the selected entity providing a reference time for which to synchronize the repeating reception/broadcast cycles.

A Coordinated Time Algorithm is used to synchronize as many Mobile Engagement Platforms (MEPs) as possible to the same time base. This algorithm describes a distributed procedure that selects one MEP as the Coordinator of a group of MEPs. The algorithm enables very fast convergence to one selected time base, and enables fast convergence when several MEP clusters, which used to belong to different CSMA/CA Domains, approach each other and “mingle”. The selected MEP Coordinator time base is the time base that will be used by all other MEPs until another Coordinator is selected by the MEPs. The procedures required in order to select the Coordinator are described below.

In order to enable the operation of the algorithm, each MEP will maintain in its storage the ID of the currently selected Coordinator. The notation for this ID is “Coordinator ID” simply “CID”.

In order to increase the chances as much as possible that the MEPs will be able to synchronize their time base with a Coordinator, a message named SYNC (a “SYNC Message”) is added to the set of HELLO and UPDATE messages transmitted and received by the MEPs. Each MEP transmits one or more SYNC messages during a HELLO+UPDATE+IDLE period. The SYNC message transmission time is selected at random and is uniformly distributed across the HELLO+UPDATE+IDLE period. (If a SYNC transmission is to occur during the IDLE period when the transmitting hardware is in sleep mode, the hardware will need to exit the sleep mode to perform the transmission and then subsequently return to sleep mode.) As illustrated in FIG. 9, the SYNC message contains the CID (as known to the sender) and the Elapsed Time (in Ticks) from the beginning of the HELLO period (of the MEP that sent the SYNC message) until the MEP submitted the SYNC message to the MAC Layer. Note that the MEP MAY receive SYNC messages only when it is contained within its HELLO or UPDATE periods (since during IDLE period the MEP TX and RX are turned OFF). Note that during IDLE period the MEP does not receive any message; it MAY only Transmit a SYNC message when it is required to do so.

The number of transmitted SYNC messages within a cycle is now discussed. The SYNC messages in conjunction with the HELLO message enable each receiving MEP to synchronize its Cycle with the rest of the MEPs.

In a sparse system, the number of HELLO messages is small and in order to speed up the synchronization process, each MEP delivers several SYNC messages distributed across the cycle (i.e., across the HELLO, UPDATE, and IDLE periods). When the system is denser, the number of SYNC messages is reduced, because more HELLO messages are received by each MEP.

The number of transmitted SYNC during HELLO and UPDATE period is reduced as a function of the number of received HELLO messages during the former Cycle. It is noted that even in a dense system (many HELLO messages received per Cycle) the minimal number of transmitted SYNC messages per Cycle is maintained at at least one SYNC per Cycle.

One implementation example is to transmit 8 SYNCs per Cycle and reduce the number of SYNCs per the counted number of HELLOs during the former Cycle. The system maintains one transmitted SYNC message per Cycle whenever the number of received HELLOs during a Cycle equals or exceeds eight HELLO messages.

The CID is initialized, for example, when a MEP is turned ON. The MEP sets its own MEP ID as the CID (CID=MEP ID) and starts NORMAL operation. Each HELLO message also contains the CID as known to the MEP that delivers the HELLO message.

The CID is updated as follows: during the HELLO and UPDATE periods the MEP may receive HELLO and or SYNC messages from other r MEPs. Per received HELLO during the MEP HELLO period, and per received SYNC during the MEP HELLO+UPDATE periods, the MEP compares the CID of each the received message with its currently known CID to be called the current CID. If the received CID>current CID, the current CID is set to the CID contained in the received message, and the stored “Tick Count Difference” is set to the Difference in Ticks Count between the Current Tick Count of the MEP and the Tick count as indicated in the received message. (The Tick count accompanies each HELLO or SYNC message). If the received CID=current CID, and the received CID is NOT equal to the MEP ID of the receiving MEP, then the stored “Tick Count Difference” is set to the Difference in Ticks Count between the Current Tick Count of the MEP and the Tick count as indicated in the received message.

At the end of the current HELLO+UPDATE period the MEP will calculate the required adjustment to its current IDLE period by readjusting the current IDLE duration by the amount of Ticks indicated by the Tick Count Difference. If the Tick Count Difference is a Positive Number, the NEXT HELLO starts at: Current IDLE termination period (+) Tick Time Difference. If the Tick Count Difference is a Negative Number, the NEXT HELLO starts at: Current IDLE termination period (−) Tick Time Difference.

Since the time base of the MEP system is not synchronized to any External stable synchronizer, synchronization “slips” will occur. In order to enhance system coordination stability, the MEPs will refresh their CID from time to time. The process of CID refresh is the same process that is used by a MEP when it is just turned ON. The CID refresh time shall be performed, for example, every Five Minutes. Once the MEP is turned ON, it will arm the CID Refresh timer. Whenever the CID Refresh timer fires, the MEP will refresh its CID and will rearm the CID Refresh timer.

Regarding the HELLO Message, when a 802.15.4 radio MAC is used as a PCA transceiver, the maximum length of a MAC message is VERY SHORT, 118 Bytes (for a non encrypted message) and a bit shorter for an encrypted message. In order to enhance the utilization of the Radio channel, it may be advantageous to shorten the length of Name List that accompanies the HELLO message thus allowing for a longer List of Profiles to accompany the profile storage delivered during the HELLO message. A MEP name is a unique ID (e.g. may be specified as the IEEE 8 Byte address of the MEP or some other product assigned Unique ID). It is possible to implement Hashed List of Names. Assume a hash function that will convert the IEEE 64 bits MAC address into 8 bits address. Of course, it is possible that several addresses will be mapped into the same-hashed address but the probability for such event is low. Even if such event occurs, no harm is done since at worst the Hashed List will not represent the exact List of Profiles (since several Names will be mapped into one name). Note that during the Update cycle the explicit Name (not the Hashed name) will be delivered together with each transmitted Profile.

The following scheme may save MEP power in slow moving MEP environments. The scheme is based on reducing the length of the HELLO message. There are two types of HELLO messages: and explicit and an implicit HELLO message.

An Explicit HELLO message is the message as was described before (i.e., the Personal Profile and Search Profile of the MEP plus the LIST of Profile Names stored at the profile storage of the HELLO sender) plus a “HELLO Sequence Number” tag (say 16 bit tag). The “HELLO Sequence Number” tag will be generated by the HELLO sender and will be incremented whenever the current HELLO is not the same as the formerly transmitted HELLO.

An Implicit HELLO contains just the formerly transmitted “HELLO Sequence Number” tag. This Implicit HELLO (very short) shall be transmitted in case the sender does not identify any change in its profile storage compared to the profile storage that was represented by the former HELLO. Thus, instead of repeating the former Explicit HELLO, the sender will send the implicit HELLO that will contain just the “HELLO Sequence Number” tag that was used in the formerly transmitted explicit HELLO message.

A MEP receiving an Implicit HELLO that contains an “HELLO Sequence Number” that was formerly received in either Implicit or Explicit HELLO will identify that there is no need to update its neighbor list. On the other hand, if a MEP receives an Implicit HELLO with an “HELLO Sequence Number” not equal to that neighbor stored Sequence Number, it will conclude that the sending neighbor has Profiles that are not known to it. During the HELLO cycle a MEP receiver may receive such Implicit HELLO from several MEPs. In the following UPDATE cycle the MEP will transmit an UPDATE REQUEST message. MEPs that receive an UPDATE REQUEST in the former UPDATE cycle will transmit an Explicit HELLO in the following HELLO cycle.

Note that in a completely static environment the HELLO messages will eventually be reduced to just implicit HELLO, and there will not be any required UPDATE. In a semi-static environment, most of the time the HELLO messages will be Implicit and from time to time an UPDATE REQUEST followed by an Explicit HELLOs will be delivered. In a highly dynamic environment it is likely that this procedure may cause the complete Profile accumulation cycle to take longer since it will constitute of a short implicit HELLO, followed by an UPDATE REQUEST, followed by an Explicit HELLO.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. For example, the data exchange mechanisms may be used in other fields, such as for disseminating road hazard information to motorists and for disseminating advertisements to potential customers in a shopping center. Accordingly, the foregoing discussion is intended to be illustrative only; the invention is limited and defined only by the following claims and equivalents thereto.

1. A social networking assembly for a local user having a local mobile telephone, the social networking assembly comprising:
a transceiving sub-assembly having a first module operative to communicate with one or more remote social networking assemblies of respective remote users;
a storage sub-assembly operative to store personal profiles describing attributes of the local and remote users and search profiles describing attributes that the local and remote users seek; and
a processing sub-assembly operative (1) to prepare personal profile data and search profile data for broadcast through the first module of the transceiving sub-assembly to the one or more remote social networking assemblies, (2) to receive broadcasted personal profile data and search profile data through the first module of the transceiving sub-assembly from the one or more remote social networking assemblies, and (3) to determine the degree to which data from a personal profile of one social networking assembly match data of a search profile of another social networking assembly.

2. The social networking assembly of claim 1, wherein the transceiving sub-assembly has a second module operative to communicate with the local telephone, and wherein the transceiving sub-assembly, the storage sub-assembly, and the processing sub-assembly reside on a mobile engagement platform that is operative to communicate with the local mobile telephone.

3. The social networking assembly of claim 1, wherein the transceiving sub-assembly, the storage sub-assembly, and the processing sub-assembly are implemented within the local mobile telephone.

4. The social networking assembly of claim 1, wherein each of the transceiving sub-assembly, the storage sub-assembly, and the processing sub-assembly individually are implemented either within the local mobile telephone or within a mobile engagement platform.

5. The social networking assembly of claim 2, wherein data for the local user's personal profile and data for the local user's search profile are loaded into the storage sub-assembly from an external server via a link through the Internet, the local mobile telephone, and the second module of the transceiving sub-assembly.

6. The social networking assembly of claim 1, wherein data for the local user's personal profile and data for the local user's search profile are loaded into the storage sub-assembly from a personal computer through the transceiving sub-assembly.

7. The social networking assembly of claim 1, wherein, after comparison of one of a personal profile and a search profile of the local user and the other of a personal profile and a search profile of a remote user, and upon determination that the degree to which the profiles match is within a predetermined range, the processing sub-assembly instructs the local mobile telephone to send a message to a remote mobile telephone associated with the social networking assembly of the remote user, the message being indicative of the profile match.

8. The social networking assembly of claim 1, wherein, after comparison of one of a personal profile and a search profile of the local user and the other of a personal profile and a search profile of a remote user, and upon determination that the degree to which the profiles match is within a predetermined range, the processing sub-assembly instructs the local mobile telephone to send a command to a remote mobile telephone associated with the social networking assembly of the remote user.

9. The social networking assembly of claim 7, wherein data of the matched profiles are uploaded to the Internet.

10. The social networking assembly of claim 1, wherein the processing sub-assembly is operative (1) to store in the storage sub-assembly profiles that were obtained from one remote social networking assembly and (2) to prepare for broadcast the stored profiles through the transceiving sub-assembly to at least one other remote social networking assembly.

11. The social networking assembly of claim 1, wherein the storage subassembly is operative to store multiple personal profiles describing the local user and/or search profiles describing what the local user seeks.

12. A method of broadcasting data from a sender to at least one recipient, the method comprising:
receiving a broadcasted notification indicating the presence of a potential data recipient;
determining from the notification whether the sender has data that the potential data recipient lacks and designating any such lacking data as candidate data for broadcast;
monitoring incoming broadcasts for data that are the same as any data designated for broadcast and removing that designation for the same data; and
broadcasting any data that remain designated for broadcast.

13. The method of claim 12, wherein a broadcasted notification is only received during a first time period, the designated data is only broadcasted during a second time period, a repeating reception/broadcast cycle is formed having a sequence including the first time period, the second time period, and a third time period, the third period being a time in which no broadcasted notification is received and no designated data are broadcasted.

14. The method of claim 13, wherein the repeating reception/broadcast cycle is synchronized with repeating reception/broadcast cycles of remote entities.

15. The method of claim 14, wherein the synchronization is set by a process that includes selecting one entity from among a group of broadcasting entities, the selected entity providing a reference time for which to synchronize the repeating reception/broadcast cycles.

16. The method of claim 13, wherein transmitting and receiving components transition to a sleep mode during the third time period.

17. The method of claim 12, wherein the broadcasted notification includes a personal profile describing attributes of the potential data recipient, a search profile describing attributes that the potential data recipient seeks, a list of profile names for which the potential data recipient has associated profiles, and an indication of time that has elapsed from a set reference.

18. The method of claim 12, wherein the data of the broadcasts include personal profiles describing attributes and search profiles describing attributes that are sought.

19. The social networking assembly of claim 8, wherein data of the matched profiles are uploaded to the Internet.
